(19) United States
(12) Patent Application Publication
(10) Pub. No.: US 2004/0099101 A1
(43) Pub. Date: May 27, 2004

(54) Wrench capable of optionally avoiding detachment of a bolt head member and allowing detachment of the bolt head member

(76) Inventor: Chih-Ching Hsien, Taichung (TW)

Correspondence Address: Charles E. Baxley, Esquire, 5th Floor, 59 John Street, New York, NY, 10038, US

(21) Appl. No.: 10/303,227

(22) Filed: Nov. 25, 2002

(51) Int. Cl. B25B 13/00

(52) U.S. Cl. 81/124.3

(57) ABSTRACT

A wrench includes a handle section with a head section which has a fitting through hole configured for fitting onto the polygonal head of a bolt head member. The fitting through hole includes first and second coaxial polygonal fitting holes circumferentially displaced from each other. Each polygonal fitting hole has an inner circumference with a plurality of reentrant angles and sides. At least one channel is formed on the inner circumference of one of the first and second fitting holes. The at least one channel extends in a direction of an axis of the fitting through hole. A sliding member is movably disposed in the at least one channel so as to prevent the polygonal head from passing completely through the fitting through hole. When the other fitting hole engages the polygonal head, the polygonal head may pass completely through the fitting through hole.

### FIELD OF THE INVENTION

The present invention relates to a wrench that has two coaxial fitting holes defined in the head of the wrench and one of the fitting holes includes sliding members received in channels defined in an inner periphery thereof so stopping the nut engaged in the head, and the other fitting holes allows the nut to pass through the fitting holes completely.

### BACKGROUND OF THE INVENTION

A conventional wrench for avoiding detachment of a screw is disclosed in the disclosure of U.S. Pat. No. 5,323,672 to Skiba which includes a locking assembly inserted into a slot defined in the web area of the box end of the wrench and a ball member is movably retained in the body of the locking assembly so as to stop a bolt head mounted by the box end. Although the bolt head can be stopped by the ball member whichever side of the box end is used to mount the bolt head, the bolt head cannot pass through the end box as an ordinary box-ended wrench.

FIG. 1 is a conventional wrench 10 having a handle 11 on which a slide collar 12 is fitted. When a tongue section 121 of the slide collar 12 is moved to the socket 14 of the wrench, the nut is stopped from slipping out of the socket 14.

FIG. 2 shows a conventional wrench 15 having a head section 16 and three pin members 17 radially pass through the head section 16 and protrude into the socket 18. As shown in FIG. 3, when the wrench 15 is fitted onto the nut 19, the nut 19 is stopped by the pin members 17 from slipping out of the socket.

FIG. 4 shows a conventional wrench 20 that has a multiangular socket 21. A projecting section 23 inward projects from top edge of each reentrant angle 22. As shown in FIG. 5, when the wrench is fitted onto a nut 24, the projecting sections 23 serve to stop the nut 24.

FIG. 6 shows an inlay channel 27 is formed on the top face of the head section 26 of the wrench 25. A ring member 28 is provided with two lugs 281 inlaid in the inlay channel 27. The ring member 28 protrudes from the reentrant angle 291 of the socket 29 for stopping the nut.

FIG. 7 shows a ring member 32 is inlaid in the head section 31 of the wrench 30. The ring member 32 protrudes from the reentrant angle 331 of the socket 33 for stopping nut.

FIG. 8 shows a ratchet wrench 35 having a ratchet 36. One side of the ratchet 36 is integrally formed with an inward extending flange 38 for stopping the nut.

All the above wrenches can be only fitted onto the nut from the open end (front face) and it is impossible to fit the wrench onto the nut from the close end (back face). This leads to inconvenience in use.

The present invention intends to provide a wrench that two coaxial polygonal fitting holes and one of which includes a sliding member received in a channel and the other fitting hole allows the polygonal object to be passed through the box end of the wrench.

### SUMMARY OF THE INVENTION

In accordance with one aspect of the present invention, there is provided a wrench that has a fitting through hole including a first and a second fitting holes circumferentially displaced from each other. One of the fitting holes has a channel defined in the inner circumference thereof so as to retain a nut in the fitting hole, and the other fitting allows the nut to passing through the fitting through hole completely.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a top view of a part of a conventional wrench;

FIG. 2 is a perspective view of another type of conventional wrench;

FIG. 3 shows the use of the wrench of FIG. 2;

FIG. 4 is a perspective view of yet another type of conventional wrench;

FIG. 5 shows the use of the wrench of FIG. 4;

FIG. 6 is an exploded view of another conventional wrench;

FIG. 7 is an exploded view of a further conventional wrench;

FIG. 8 is a perspective view of another conventional wrench;

FIG. 9 is a perspective view to show the wrench of the present invention;

FIG. 10 is a top cross sectional view to show the box end of the wrench of the present invention;

FIG. 11 is a side cross sectional view to show the box end of the wrench of the present invention;

FIG. 12 is a top view to show the wrench of the present invention;

FIG. 13 shows a bolt head is stopped by the sliding members in the channel of the wrench of the present invention;

FIG. 14 shows the bolt head is stopped by the sliding members in the channel of the wrench of the present invention when the wrench is mounted onto the bolt head by the reverse side;

FIG. 15 shows only two reentrant angles of the wrench of the present invention has the sliding member received therein;

FIG. 16 shows the fitting through hole includes two fitting holes and one of which has sliding members;

FIG. 17 shows the bolt head may pass through the fitting through hole completely;

FIG. 18 shows the channels are defined in the insides of the polygonal of the fitting through hole, and

FIG. 19 shows the box end as shown in FIG. 16 is used in a ratchet wrench.

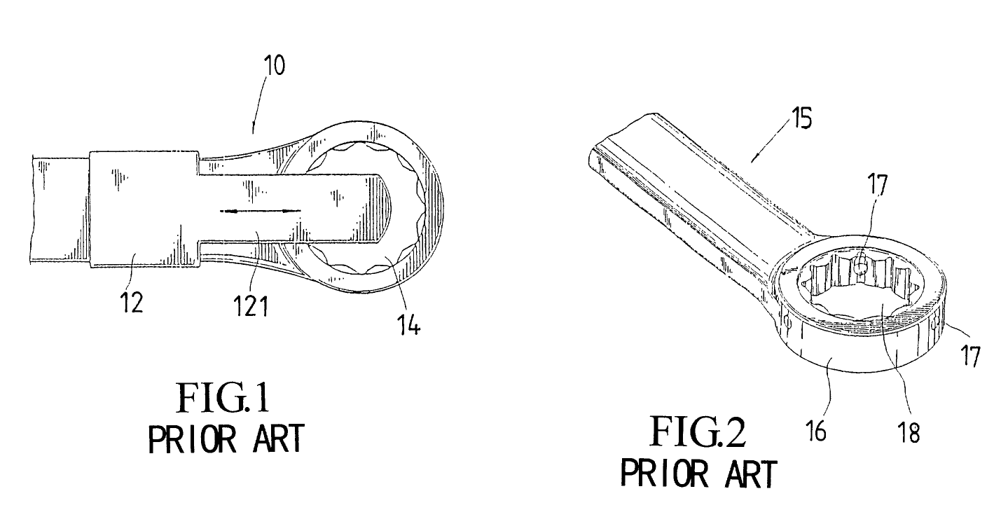

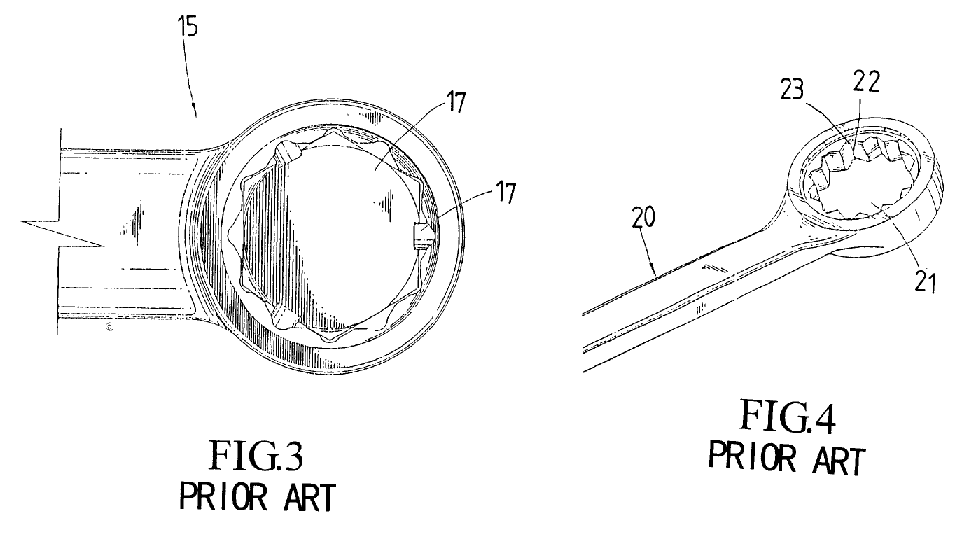

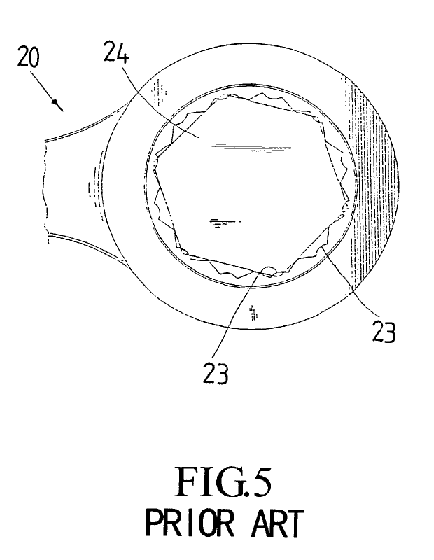

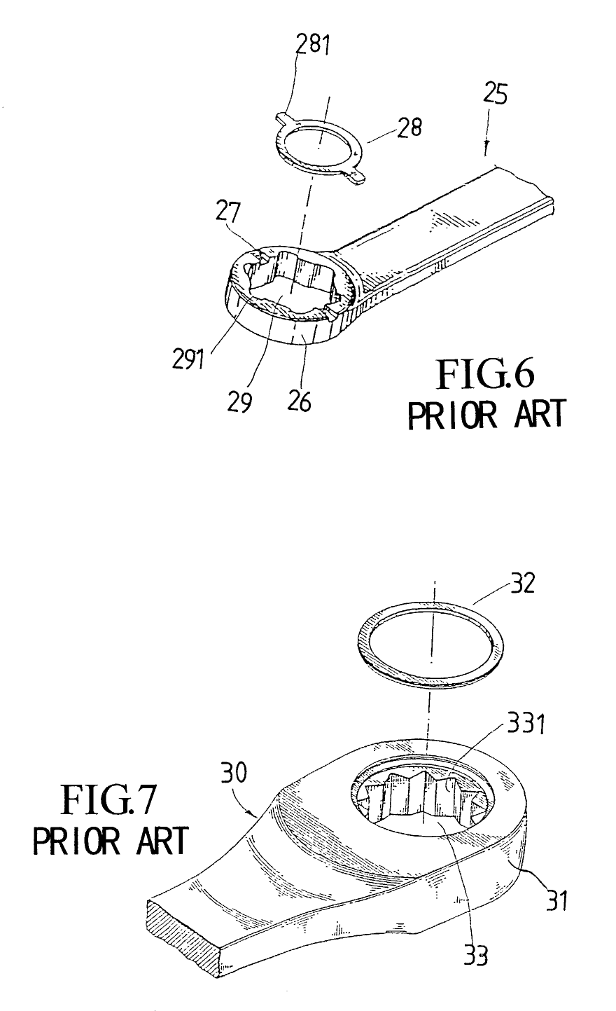

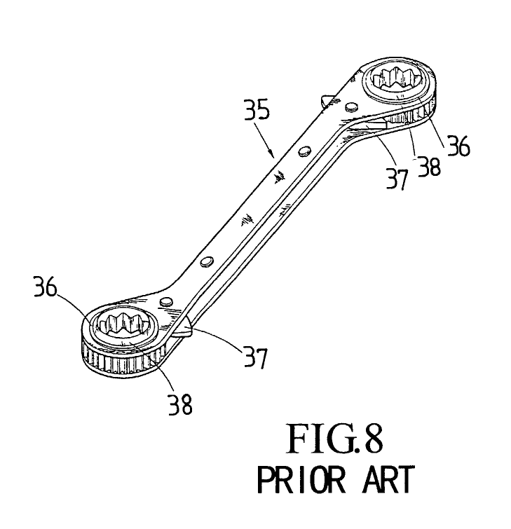

### DETAILED DESCRIPTION OF THE PREFERRED EMBODIMENTS

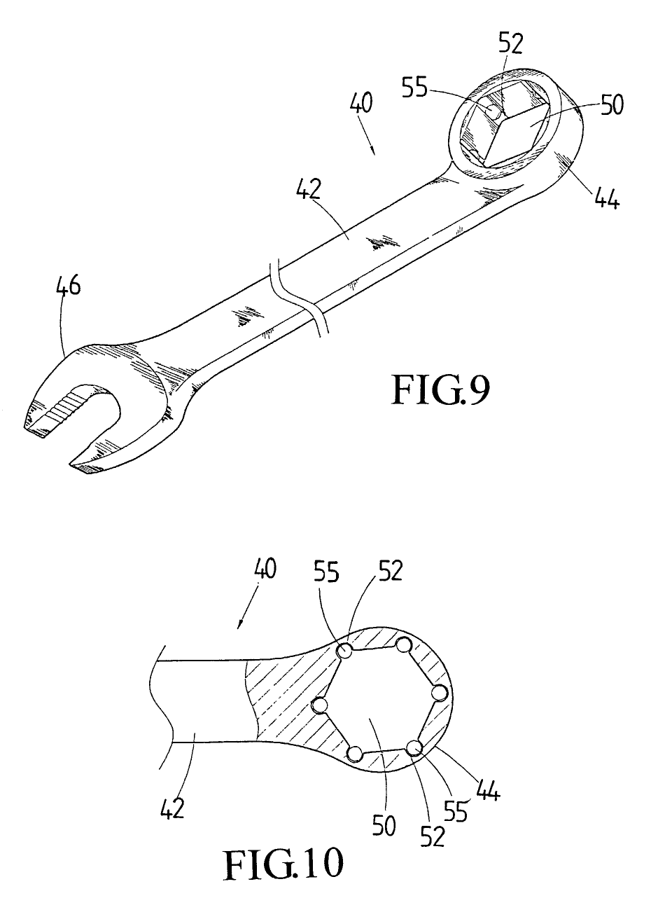

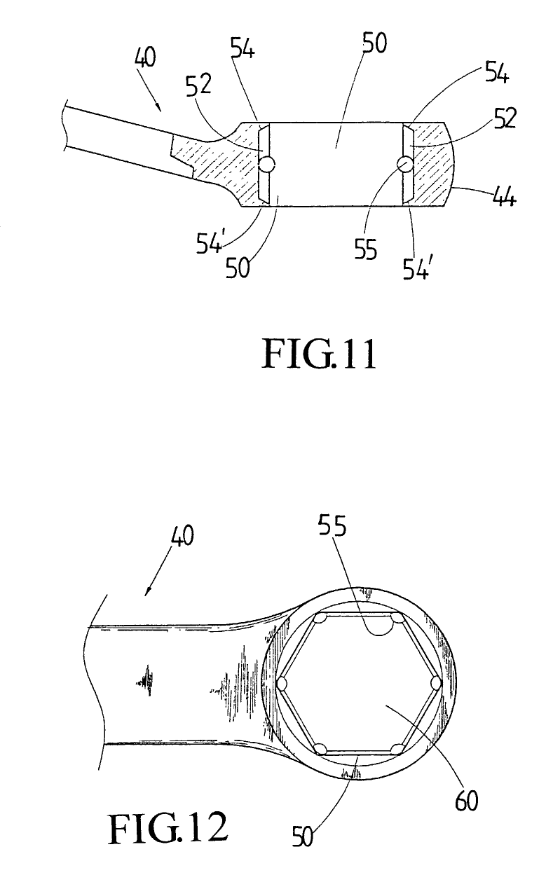

Referring to FIGS. 9 to 13, the wrench 40 of the present invention comprises a handle section 42 and a head section 44 and open end 46 respectively formed at two ends of the handle section 42. The head section 44 is formed with a hexagonal fitting through hole 50 and six reentrant angles and six sides are defined in an inner circumference of the fitting through hole 50. Each reentrant angle is formed with a channel 52 in the direction of an axis of the fitting hole 50. The channels 52 communicate with the fitting hole 50 and has an interior and an opening is narrower than the interior. A top end and a bottom end of each of the channels 52 are respectively provided with two stop sections 54, 54′.

Six sliding members 55 are movably received in the channels 52 and are steel balls which partially protrude from the opening of the channels 52 into the fitting through hole 50. The opening of the channel is narrow enough so that the sliding member 55 is prevented from dropping out of the channel 50. The upper and lower stop sections 54, 54′ serve as upper and lower dead ends for the sliding members 55.

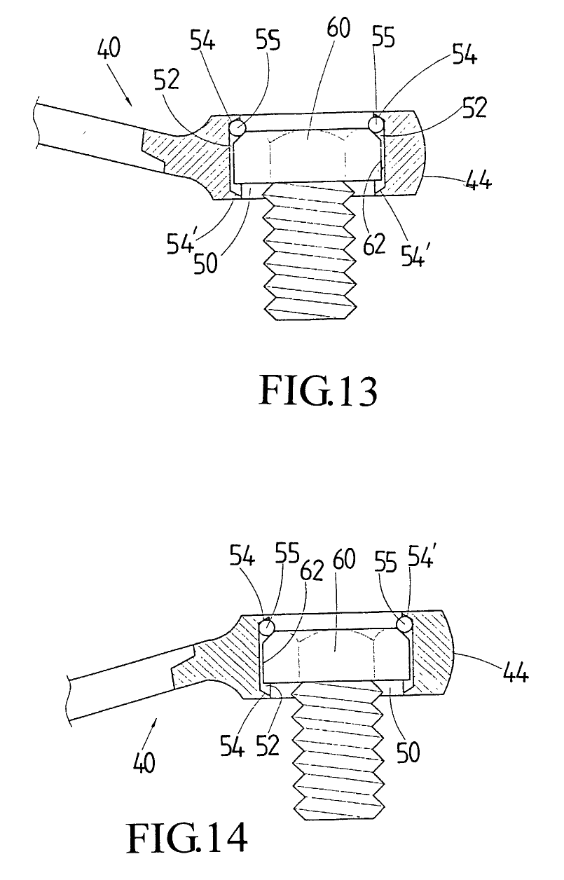

When using the wrench 40 from front face thereof as shown in FIGS. 12 and 13, the fitting through hole 50 is downward fitted onto a nut or a bolt 60 with the angles 62 of the bolt aimed at the reentrant angles of the fitting through hole 50. At this time, the angles 62 of the bolt will touch the sliding members 55. When the bolt 60 is slid into the fitting through hole 50, the sliding members 55 are pushed by the bolt and upward moved along the channels 52. After the sliding members 55 are moved to the upper stop section 54 and stopped thereby, the bolt is stopped and located by the sliding members 55 without departing from the wrench 40.

Alternatively, the wrench 40 can be fitted onto the bolt from back face of the fitting hole as shown in FIG. 14. The upper stop section 54 is positioned on the lower side and the lower stop section 54′ is positioned on the upper side. The sliding members 55 are pushed by the bolt 60 and moved within the channels 52. After the sliding members 55 are moved to the lower stop sections 54′ and stopped thereby, the bolt is stopped by the sliding members 55 and prevented from departing from the wrench 40.

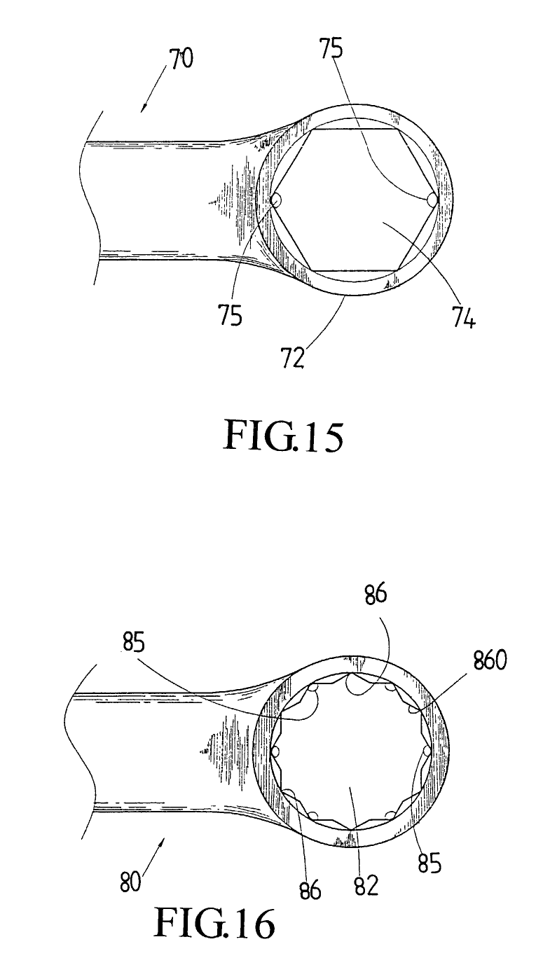

FIG. 15 shows another embodiment of the present invention wherein the a hexagonal fitting through hole 74 is defined in the head section 72 of the wrench 70 and only two reentrant angles of the fitting through hole 74 are provided with channels in which two sliding members 75 are respectively and movably retained therein. The wrench 70 can be fitted onto a bolt from front or back face to achieve the same effect as shown in FIGS. 13 and 14.

FIG. 16 shows yet another embodiment wherein the fitting through hole 82 of the wrench 80 is dodecagonal and includes first and second coaxial hexagonal fitting holes circumferentially displaced from each other. Each hexagonal fitting hole has an inner circumference with a plurality of reentrant angles 86 and sides 860. At least one channel is formed on the inner circumference of only the first of the first and second fitting holes. In this embodiment, the at least one channel is defined in the reentrant angles 86 extends in a direction of an axis of the fitting through hole 82.

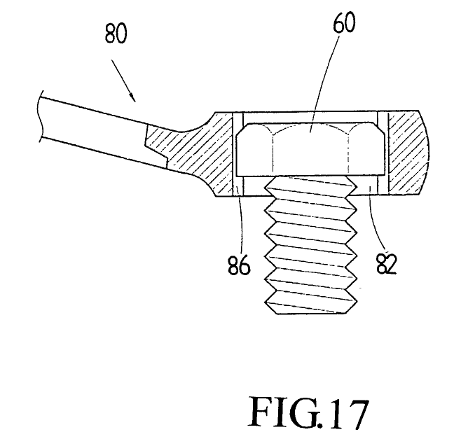

A sliding member 85 is movably disposed in the at least one channel so as to move therein without dropping out of the channel. The sliding member 85 protrudes from the channel into the first fitting hole. The channel has upper and lower dead ends to limit movement of the sliding member 85 in the at least one channel as described in the above description embodiments. When the first fitting hole engages the polygonal head 60 from either side, the sliding member 85 prevents the polygonal head 60 from passing completely through the fitting through hole 82. When the second fitting hole engages the polygonal head 60 as shown in FIG. 17, the polygonal head 60 may pass completely through the fitting through hole 82.

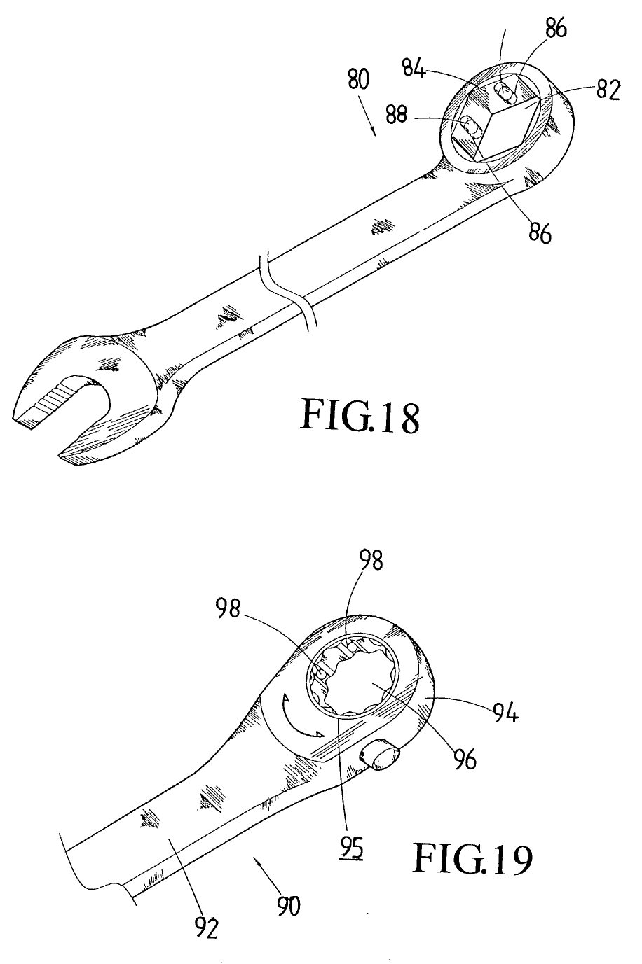

FIG. 18 shows that the channels 86 are defined in the sides 84 of the fitting through hole 82 and sliding members 88 are movably retained in the channels 86. FIG. 19 shows a ratchet wrench 90 which has a handle section 92 and a ratchet mechanism received in the head 94 of the wrench 90. An engaging ring 95 is rotatably engaged in the hole in the head 94 and includes a polygonal inner periphery 96 wherein channels 98 are defined in the insides or reentrant angles. A sliding member 98 is movably retained in the channels 98.

While we have shown and described the embodiment in accordance with the present invention, it should be clear to those skilled in the art that further embodiments may be made without departing from the scope of the present invention.

What is claimed is:

1. A wrench capable of avoiding detachment from a polygonal head of a bolt head member, and comprising:
a handle section;
a head section disposed at one end of the handle section, the head section having a fitting through hole configured for fitting onto the polygonal head of a bolt head member, the fitting through hole forming first and second coaxial polygonal fitting holes circumferentially displaced from each other, each polygonal fitting hole having an inner circumference with a plurality of reentrant angles and sides;
at least one channel formed on the inner circumference of only the first of the first and second fitting holes, the at least one channel extending in a direction of an axis of the fitting through hole; and
a sliding member movably disposed in the at least one channel so as to move thereon without dropping out of the channel, the sliding member protruding from the channel into the first fitting hole, the channel having upper and lower dead ends to limit movement of the sliding member in the at least one channel, whereby, when the first fitting hole engages the polygonal head from either side, the sliding member prevents the polygonal head from passing completely through the fitting through hole, and when the second fitting hole engages the polygonal head, the polygonal head may pass completely through the fitting through hole.

2. The wrench as claimed in claim 1, wherein the at least one channel is formed in at least one of the plurality of reentrant angles of the first fitting hole.

3. The wrench as claimed in claim 1, wherein the at least one channel is formed in at least one of the plurality of sides of the first fitting hole.

4. The wrench as claimed in claim 1, wherein the top and bottom ends of the at least one channel each have a stop section, whereby when the sliding member moves within the at least one channel, the stop sections stop the sliding member and serve as the upper and lower dead ends.

5. The wrench as claimed in claim 1, the at least one channel has an interior and an opening narrower than the interior, whereby the sliding member is received in the channel and prevented from dropping out.

6. The wrench as claimed in claim 1, wherein the sliding member comprises a steel ball.

7. The wrench as claimed in claim 1, wherein each of the first and second fitting holes has a hexagonal configuration.

8. A wrench capable of avoiding detachment from a polygonal head of a bolt head member, and comprising:
a handle section;
a head section disposed at one end of the handle section, the head section having a fitting through hole configured for fitting onto the polygonal head of a bolt head member, the fitting through hole comprising a plurality of reentrant angles and sides;
at least two channels defined in two of the reentrant angles of the fitting holes and extending in a direction of an axis of the fitting through hole; and
a sliding member movably retained in each of the at least two channels and protruding from the at least two channels into the fitting hole, each of the at least two channels having upper and lower dead ends to limit movement of the sliding member.

9. The wrench as claimed in claim 8, the at least two channels each have an interior and an opening narrower than the interior, whereby the sliding member is received in the channel and prevented from dropping out.

10. A wrench capable of avoiding detachment from a polygonal head of a bolt head member, and comprising:
a handle section;
a head section disposed at one end of the handle section, the head section having a fitting through hole configured for fitting onto the polygonal head of a bolt head member, the fitting through hole comprising a plurality of reentrant angles and sides;
at least two channels defined in two of the sides of the fitting holes and extending in a direction of an axis of the fitting through hole; and
a sliding member movably retained in each of the at least two channels and protruding from the at least two channels into the fitting hole, each of the at least two channels having upper and lower dead ends to limit movement of the sliding member.

11. The wrench as claimed in claim 10, the at least two channels each have an interior and an opening narrower than the interior, whereby the sliding member is received in the channel and prevented from dropping out.
